(19) United States
(12) Patent Application Publication
(10) Pub. No.: US 2024/0394898 A1
(43) Pub. Date: Nov. 28, 2024

(54) SPEED AND LANDING ZONE MANAGEMENT SYSTEM

(71) Applicant: PRECISION APPROACH LLC, oregon City, OR (US)

(72) Inventor: Christopher L. PEDROTTI, Incline Village, NV (US)

(21) Appl. No.: 18/692,959

(22) PCT Filed: Sep. 19, 2022
(86) PCT No.: PCT/US2022/043971

§ 371 Date: Mar. 18, 2024

Related U.S. Application Data
(60) Provisional application No. 63/245,826, filed on Sep. 18, 2021.
(60) Provisional application No. 63/320,392, filed on Mar. 16, 2022.

(51) Int. Cl. G06T 7/292; G06T 7/246; G06V 20/52; H04N 7/18

(52) U.S. Cl. CPC G06T 7/292; G06T 7/248; G06V 20/52; H04N 7/181; G06T 2207/30196; G06T 2207/30221

(57) ABSTRACT

A system is configured for approach speed management and landing zone management. A camera and/or lidar system is used to monitor a landing zone area of a terrain park feature such as a jump in a snow sports resort. The approach speed of a user is also determined. A user in a start zone or approaching the feature is given an indication when the landing zone is not clear, and information as to whether the user's approach speed is outside of a target zone indicating risk of undershooting or overshooting the landing zone. Video may be captured and selectively transmitted to a user depending on payment or subscription status of the user.

### REFERENCE TO RELATED APPLICATIONS

This patent application claims the benefit of and incorporates by reference each of the following provisional applications:
U.S. Prov. Ser. No. 63/320,392 filed Mar. 16, 2022; and
U.S. Prov. Ser. No. 63/245,826 filed Sep. 18, 2021.

All of the above-referenced patent applications are collectively referenced herein as “the commonly assigned incorporated applications.”

### FIELD

This patent specification generally relates to management of a speed and landing zones. More particularly this specification relates to management of user speed and/or landing zones in recreational settings such as features in terrain parks in snow sports and other settings.

### BACKGROUND

Many snow ski resorts include terrain park areas that feature man made jumps of various sizes. Each feature is designed to be used at an appropriate speed such that the skiers momentum will carry them to the designated landing zone. As used herein, the terms “skier” and “skiers” are understood to include any participant using any devise allowed by ski resorts for use on their mountain, including but not limited to snowboarding, sledding, and ski biking

The landing zone is a steep section where the transition from air to ground is smooth. If the skier is moving too fast or too slow, the skier is put at risk of landing on either the flat area after the landing zone or the flat area before the landing zone putting them at greater risk of injury. Additionally, there is often no effective way to determine if this landing zone is clear of others or objects, as the landing zone is often not visible from above where one begins their approach to the feature. A proposal has been made to provide skiers with some information regarding risks of a jump, see U.S. Pat. No. 8,482,417, but it is believed that a need still remains for a more effective system to enhance safety, convenience, and enjoyment in such setting.

### SUMMARY

According to some embodiments, a system enhancing safety in a ski jump feature that includes a run comprising, in a downstream sequence, a starting zone for a skier to start a run, a downwardly sloping zone for the skier to build up speed, a ramp zone from which the skier is to jump off, a flying zone over which the skier is to travel through the air, a landing zone for the skier to land, and a zone for the skier to end the run, and the run further comprises a side area that is to a side of said flying zone, comprises; a housing mounted at said side area, spaced from said run, and supporting sensors configured to monitor said run and further housing a computer operatively coupled to the sensors; wherein said sensors and computer are configured to: individually detect the skier's speed in real time at each of multiple points in the run between the start zone and the end of the ramp zone; track weather conditions at the run; and detect the presence or absence of obstructions in said run; plural displays positioned to be visible by the skier at least upstream of said flying zone and driven by said computer based on input from said sensors, to indicate to the skier: the presence or absence of dangerous conditions at the run; in real time and at each of plural points in the run: whether the skier's speed is within a selected range; if the skier's speed is outside the selected range: whether the speed is too fast or too slow relative to the selected range; and whether the departure of the skier's speed from the selected range exceeds a threshold; and a wireless communication facility configured to transmit, to a wireless personal device carried by the skier, at least some of the indications at said plural displays.

According to some embodiments, the system can further include one or more of the following features: (a) the sensors configured to track weather conditions at the run can include an anemometer measuring wind speed and direction at the run, and said computer can respond to outputs from the anemometer to automatically adjust said selected speed range; (b) the sensors configured to individually detect the skier's speed at each of said multiple points can comprise a camera system viewing at least the ramp zone and supplying said computer with real time images, and said computer can be configured to estimate the skier's speed at each of said multiple points based at least in part on said images; (c) the sensors configured to detect the presence or absence of obstructions in said run can include a camera system viewing the landing zone and the flat zone and supplying images thereof to said computer, and said computer can be configured to process said images to detect the presence of absence of obstructions at the landing zone and the flat zone; (d) the sensors configured to detect the presence or absence of obstructions in said run can include plural imaging devices viewing the run from plural, spaced-apart viewing points; (e) said wireless facility configured to transmit to a wireless device carried by the skier can be configured to cause the wireless device to issue audible and/or vibration indications conforming to at least some of the indications displayed at said plural displays; (f) said computer can be further configured to receive empirical data regarding current run conditions derived by observations at the run at selected time intervals and to automatically adjust said selected speed range accordingly; (g) the system can further include a fail-safe display activated in case of a failure of displaying said indications to display a sign visible from the starting zone to the effect that the run is currently unsafe; (h) the system can further include a facility configured to store and selectively transmit to skiers and/or others still and/or video images taken with said sensors; (i) said still and/or video images can be configured to enhance education and/or increase enjoyment of said ski jump feature; (j) the sensors configured to individually detect the skier's speed at each of multiple points can comprise a Lidar and said computer can be configured to estimate the skier's speed at each of said multiple points based at least in part on input from said Lidar; and (k) said sensors and computer can be further configured to detect the skier's speed in real time continuously during at least part of the run between the start zone and the end of the ramp zone.

According to some embodiments, a speed and landing zone management system for a facility that includes a run comprising a ramp over which a person speeds and a terminal portion that is at the end of the ramp and from which the person jumps toward a landing zone, comprises: a supporting member extending up from a base supported at a site that is spaced laterally from the terminal portion of the ramp to be outside the run, thereby reducing risks of the person colliding therewith; a housing supported by said supporting member; sensors at least some of which are at the housing and are configured to detect motion of the person on said ramp and selected parameters at said run; a computer operatively coupled with the sensors and configured to respond to inputs from the sensors to: individually estimate, based on inputs from the sensors, the speed of the person on the ramp; and determine the presence or absence of obstructions in the run; at least one display operatively connected to the computer and configured to concurrently display to the person on the ramp each of: real time indications, based on the estimates of the person's speed and whether the person's speed conforms to a selected speed range; and real time indication of the presence or absence of obstructions in the run.

According to some embodiments, the system described in the immediately preceding paragraph can further include one or more of the following features: (a) the system can further include weather condition sensors at said run, and said computer can be configured to respond to inputs from said weather condition sensors to automatically adjust said selected speed range for greater safety of persons using the run; (b) said weather condition sensors can include a sensor of wind strength and direction at the run; (c) said weather condition sensors can include sensors both for air and for snow temperatures at the run; (d) the system can further include a wireless facility operatively coupled with said computer and configured to transmit to a wireless device carried by the person to cause the wireless device to issue an audible and/or vibration indication conforming to at least some of the indications displayed at said plural displays; (e) said sensors can comprise a Lidar, and said computer can be configured to estimate the person's speed at each of multiple points based at least in part on input from said Lidar; (f) said run can be a ski jump run and said computer can be further configured to detect, based on inputs from said sensors, the presence or absence of obstructions at said landing zone; (g) said run can be a ski jump run and said computer can be further configured to detect, based on inputs from said sensors, the presence or absence of dangerous conditions at a zone downstream from said landing zone; (h) said sensors and computer can be further configured to sense and detect the speed of the person at multiple locations approaching the terminal portion of the ramp; and (i) said sensors and computer can be further configured to detect the skier's speed in real time continuously during at least part of the run between the start zone and the end of the ramp zone.

According to some embodiments, a method of enhancing safety at a jump feature at which a person travels over a run that includes a ramp and a landing zone, comprises: individually estimating the person's real time speed at each of multiple points over the ramp by computer processing outputs of sensors that are mounted at a location that is laterally offset from the run, extends higher than a lip at the end of the ramp, and are supported at a base that is vertically spaced from the lip; monitoring the landing zone for obstructions in real time; concurrently displaying, at one or more locations visible to a person traveling toward the lip: indications of the presence of absence of obstructions in the landing zone based on said real time monitoring of the landing zone; and indications whether the person's speed over the ramp conforms to a selected speed range based on said estimates of the person's real time speed at each of said multiple points over the ramp.

According to some embodiments, the method can further include one or more of the following features: (a) sensing selected weather conditions at the run and automatically adjusting said speed range with said computer based on the sensed weather conditions; and (b) said concurrent displaying can further include displaying indications of a degree by which the person's speed is outside said selected speed range.

### BRIEF DESCRIPTION OF THE DRAWINGS

To further clarify the above and other advantages and features of the subject matter of this patent specification, specific examples of embodiments thereof are illustrated in the appended drawings. It should be appreciated that elements or components illustrated in one figure can be used in place of comparable or similar elements or components illustrated in another, and that these drawings depict only illustrative embodiments and are therefore not to be considered limiting of the scope of this patent specification or the appended claims. The subject matter hereof will be described and explained with additional specificity and detail through the use of the accompanying drawings in which:

FIG. 1 is a diagram schematically illustrating a jump feature at a terrain park in a snow ski resort, according to some embodiments;

FIG. 2 is a diagram schematically illustrating a speed and landing zone management system installed near a jump feature at a terrain park in a snow ski resort, according to some embodiments;

FIGS. 3A to 3D are diagrams illustrating further aspects of a speed and landing zone management system installed near a jump feature at a terrain park in a snow ski resort, according to some embodiments;

FIG. 4 is a schematic diagram illustrating further details of various components of a speed and landing zone management system and some interactions between such components, according to some embodiments;

FIGS. 5A-5C are diagrams illustrating further details of visual indicators to a user by a speed and landing zone management system, according to some embodiments;

FIG. 6 is a diagram showing a speed and landing zone management system, according to some embodiments; and

FIG. 7 is a diagram showing example dimensions for components of a speed and landing zone management system, according to some embodiments.

### DETAILED DESCRIPTION

A detailed description of examples of preferred embodiments is provided below. While several embodiments are described, it should be understood that the new subject matter described in this patent specification is not limited to any one embodiment or combination of embodiments described herein, but instead encompasses numerous alternatives, modifications, and equivalents. In addition, while numerous specific details are set forth in the following description in order to provide a thorough understanding, some embodiments can be practiced without some or all of these details. Moreover, for the purpose of clarity, certain technical material that is known in the related art has not been described in detail in order to avoid unnecessarily obscuring the new subject matter described herein. It should be clear that individual features of one or several of the specific embodiments described herein can be used in combination with features of other described embodiments or with other features. Further, like reference numbers and designations in the various drawings indicate like elements.

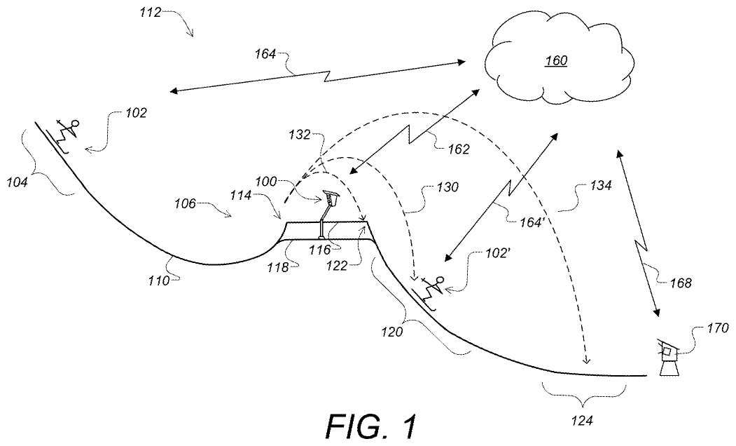

FIG. 1 is a diagram schematically illustrating a jump feature at a terrain park in a snow ski resort, according to some embodiments. A terrain park feature of FIG. 1 is shown in a side view with snow surface 110. The jump feature 112 includes take off zone 104 followed by a downward sloping area configured to allow skier to build up speed, ramp zone 106, landing zone 120 and flats area 124. The landing zone 120 is where skiers transition from air to ground is smooth due to the steepness of the incline. Note that the landing zone 120 is also sometimes referred to as the sweet spot. The ramp 106 also includes lip 114, table 116 and knuckle 122. Jump 112 also commonly includes side flatter table area. Side table 118 is shown on the right side of the jump. Skier 102 is shown in a starting zone 104. The trajectory and distance the skier travels through the air for a given jump feature, generally depends on the speed of the skier 102 when the skier hits the lip 114 at the end of ramp 106, and other factors such as the amount and timing of “pop” by the skier, wind speed and wind direction. The trajectory 130 of skier 102 will allow for landing at the landing zone 120. If the skier is moving too slowly, the skier 102 is at risk of “undershoot” such as shown by trajectory 132. Undershoot risks the skier 102 landing on the flat table 116 or knuckle 122 of the jump. If skier is moving too quickly, the skier 102 is at risk of “overshoot” such as shown by trajectory 134. Overshoot risks the skier 102 landing past the landing zone in flat area 124. Both undershoot and overshoot generally decreases the enjoyment of the jumping experience, and also generally increases the risk of injury to skier 102. Additionally, since the ramp 106 often blocks a good view of landing zone 120 by skier 102 in the starting zone 104, there is often not a convenient way for skier 102 to determine if landing zone 120 is clear of other skiers or objects.

Currently, it is sometimes recommended to use a second skier to “shadow,” or “lead in” the first skier in tandem, providing a physical demonstration, and coaching the first skier toward the correct speed for the particular feature. Also, an additional (third) skier may be required to be in a position to view the landing zone and confirm it is clear of objects. Note that although the labels “first” and “second” etc are used herein, the skiers can move through a run in any order. For example, the second, or shadow skier, can actually start before or ahead of the first skier.

Drawbacks of current jump features in terrain parks include, but are not limited to: (1) a skier unable to enjoy the feature safely while skiing alone; (2) a skier is unable to know the “shadow” skier is aware of the current correct speed for the feature himself; (3) once an approach starting point is established, it can change throughout the day as snow conditions are modified by both temperature and sun/snow exposure; and (4) the landing zone often cannot be viewed and confirmed clear prior to start of the approach.

According to some embodiments, systems are described which eliminate and/or significantly reduce some or all of these drawbacks. According to some embodiments, skiers are provided with a visual indication of their approach speed relative to the “target” speed at which the feature was intended to be enjoyed. As well as an uphill indication of the status of the landing zone to confirm it is clear to enjoy the feature.

According to some embodiments, aspects of the system may have one or more of the following: (1) long term speed calibration, and in some cases speed calibration for the life of the feature; (2) ease of installation of tower via ski gate ends already available on mountains; (3) ease of installation of routine components such as electric batteries which might be installed regularly, such as daily; and (4) components that need environmental protection are protected from elements within an enclosure.

According so some embodiments, system tower 100 is configured to communicate with a network 160. Connectively between tower 100 and network 160 can be a wireless connection such as illustrated by arrow 162 and/or wired link, or a combination thereof. Additionally, according to some embodiments, the system tower 100 can be in communication with skier 102 (in any position, such as shown in 102 and 102′ in FIG. 1) via wireless communication via network 160, as shown by arrows 164 and 164′. According to some embodiments, direct wireless can be made between system tower 100 and the skier (102 and 102′) via technologies such as bluetooth, wi-fi network, and or RFID. In cases where range is an issue, separate repeater units can be used.

According to some embodiments an auxiliary unit can be used to house a camera 170. This might be the case where due to the positioning of the system tower 100 and the feature size and shape, a clear view may not be feasible from the position of tower 100. Although camera 170 is shown mounted below the landing zone 120 in FIG. 1, in practice a camera could be mounted in suitable location such as off to the side of the feature. According to some embodiments, a second system tower such as tower 100 which includes its own lidar system and/or camera(s), computer and communications units can be used in cases where the landing zone is difficult to monitor with a single system tower. Using a second, self-contained system tower 100 has a benefit of having standardized units that can be “plug and play” and/or “drop and go” in some applications.

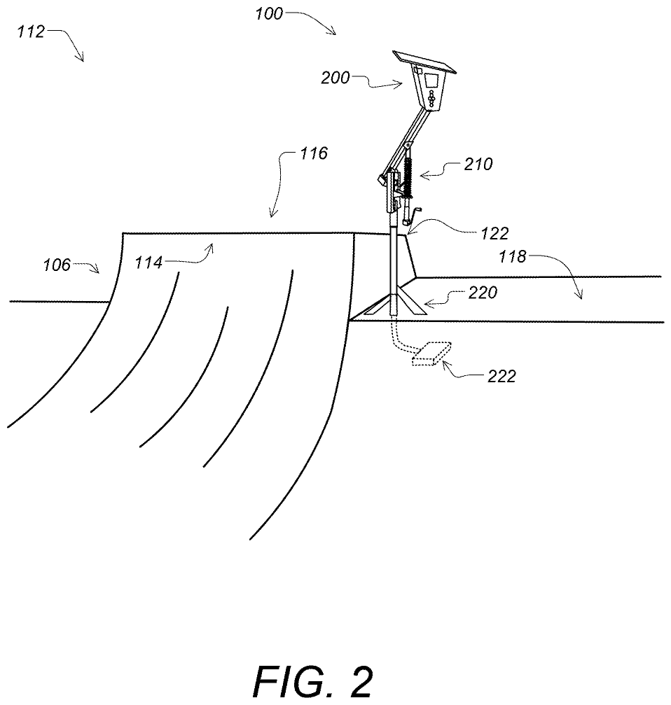

FIG. 2 is a diagram schematically illustrating a speed and landing zone management system installed near a jump feature at a terrain park in a snow ski resort, according to some embodiments. Shown is a portion of jump feature 112 including ramp 106, lip 114, table area 116, knuckle 122 and side table 118. System tower 100 includes enclosure housing 200, arm 210 and base 220. The system tower 100 is shown mounted on side table area 118 on the right side of the jump. According to some embodiments, the base 220 can include under snow support structures such as anchor and support 222 which is configured to be buried as shown in FIG. 2.

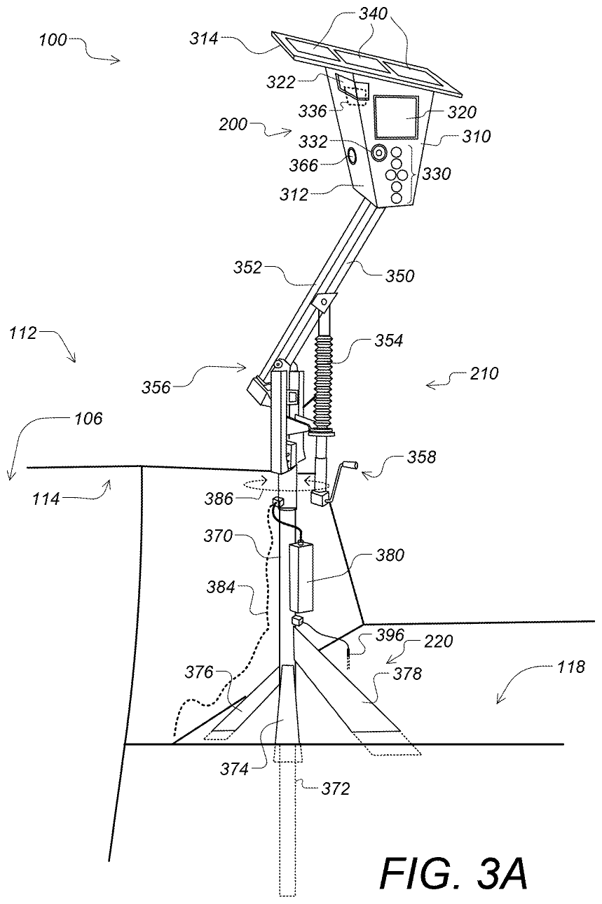

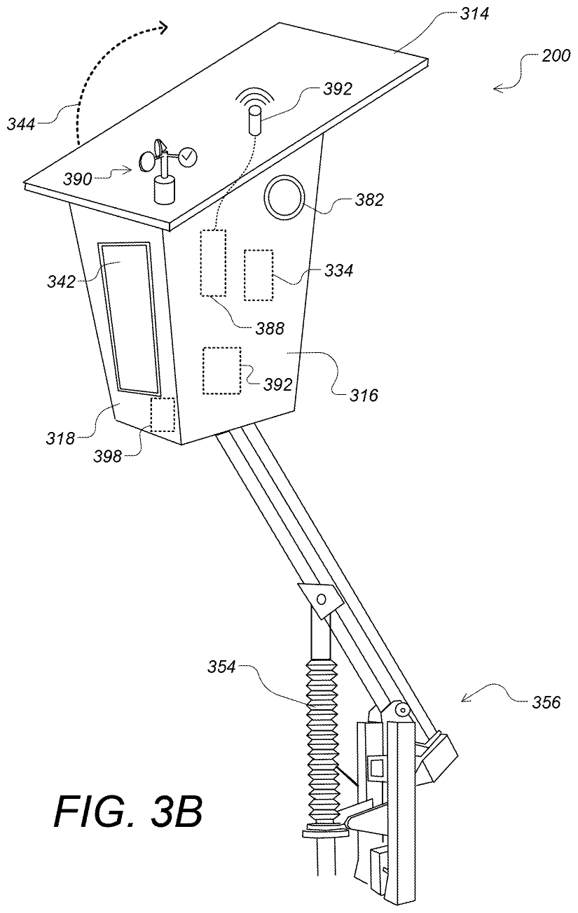

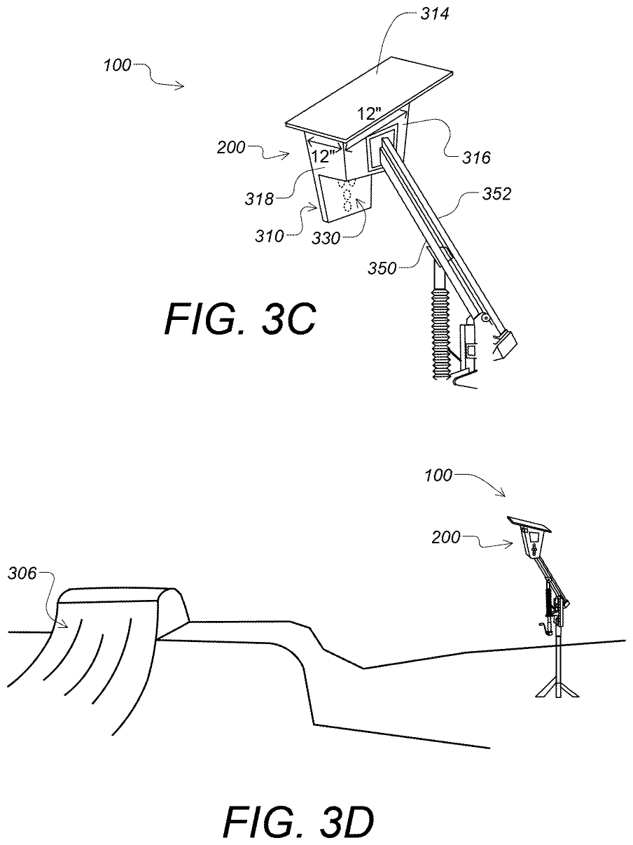

FIGS. 3A to 3D are diagrams illustrating further aspects of a speed and landing zone management system installed near a jump feature at a terrain park in a snow ski resort, according to some embodiments. The housing 200 is a four-sided enclosure of which two sides are visible in FIG. 3A, namely the uphill-facing side 310 and jump-facing, or feature facing side 312. Visible in FIG. 3B are downhill facing side 316 and away facing side 318. The housing 200 also includes a hood or cover 314 which is configured to provide the contents of the housing 200 as well as the various ports, windows and indicators with protection from precipitation and sun. According to some embodiments, the cover 314 is not flat as shown in FIGS. 3A and 3B. According to some embodiments, other angles (e.g. slope angle), other sizes (e.g. amount of overhang), and other shapes can be used. For example, according to some embodiments, the cover 314 has a saddle shape such as a hyperbolic paraboloid. According to some embodiments, the cover 314 has a rounded teardrop shape, with its rounded end pointed at the jump feature. Furthermore, according to some embodiments cover 314 is made of a flexible or semi-flexible material. According to some embodiments, padding (not shown) is provided on cover 314.

According to some embodiments, access the components within housing 200 is provided via tilting cover 314 such as shown in FIG. 3B with dashed arrow 344. The direction of tilt, and therefore the location of the hinge(s) will depend on the most convenient access angle to the housing 200 for the particular application. According to some embodiments, instead of or in addition a tilt-able cover 314, an access door 342 is provided such as on away facing side 318.

The uphill-facing side 310 has an approach speed color light display 330, and an LED display 320 which can be used, for example, to display landing zone status. Uphill-facing side 310 can also include part of the sensor window 322, as shown in FIG. 3. According to some embodiments, the sides, cover and/or floor of housing 200 are insulated with suitable material to protect the internal components of housing 200 from the exterior environment. Window 322 can be double-paned glass for enhanced insulation of the contents of housing 200 as well as reducing risk of fogging or other condensation related issues. Behind window 322 and within housing 200 is lidar system 336 which is configured to determine ranges, distances and speeds associated with the target skier 102. Examples of suitable lidar systems include VLP-16 Puck made by Velodyne, although many other lidar systems can be used depending on the application. Also housed within housing 200 is computer system 334, shown in FIG. 3B. Examples of suitable computer systems include a single-board computer such as type of Jettson by Nvidia, or Raspberry Pi computer, although many other types of computer systems can be used depending on the application. According to some embodiments, the Lidar system 336 is also able to “view” the landing zone from display window 322. According to some embodiments, a webcam type camera, such as a pi camera and a raspberry pi computer are used to “view” area 120. Also housed within housing 200 is communications system 388, which in some cases is configured to provide wireless communication via antenna 392 with a network 160 and skier 102 (and 102′) shown in FIG. 1. According to some embodiments, communications system 388 can use a wired connection, for example via communications included with power line 384. According to some embodiments communications system 388 includes an LTE radio installed within the enclosure 200 that is configured to provide remote monitoring of various components and integrations within the housing 200 via cellular data. According to some embodiments, a heater 392 is housed within housing 200. The heater 392, that includes a temperature sensor, can be configured to maintain temperature in housing 200 in a range that is suitable for operation of the various components housed therein. Examples of a suitable heater is Stage HG140, or CP061 PTC Heater, although many other heater systems can be used depending on the application. According to some embodiments, non-electrical type heater, for example chemical reaction heating elements might be used alone or in combination with an electrical heater. According to some embodiments, thermostat-controlled louvers (not shown) can actuate electric venting of the enclosure 200 to prevent overheating.

According to some embodiments, the system includes a loudspeaker 332 which can be paired with a light display to give an approaching skier an increased awareness of the skier's speed relative to a target speed.

According to some embodiments, instead of or in addition to using a loudspeaker, audio and/or vibration alerts can be given to approaching skiers via their personal devices, such as smart phones to give the approaching skier an increased awareness of the skier's speed relative to a target speed.

According to some embodiments, one or more solar panels 340 are positioned on the housing 200 such as on the cover 314 as shown in FIG. 3A. The solar panel(s) can be used to generate power for charging batteries, components, heating and/cooling (e.g. fans, not shown).

According to some embodiments, power for some or all of the electrical components in system tower 100 is provided by rechargeable battery pack 380. Examples of suitable battery systems include a D/C power system by Dakota Lithium, although many other battery systems can be used depending on the application. In some cases, battery pack 380 is mounted on or near base 220 for ease of access for installing or swapping battery packs, as well as significantly reducing the mass of the contents of housing 200. According to some other embodiments, battery pack 380 is housed within housing 200 for greater control over environmental conditions such as temperature and humidity. According to some embodiments, alternatively or in addition to battery pack 380, electrical power can be supplied via a power line 384 shown in dashed line in FIG. 3A.

According to some embodiments, the positioning of housing 200 is controllable via a hinge system 356 and arms 350 and 352. The hinge system can include coiled spring unit 354 and a crank arm 358 to allow for manual control over the height of the housing 200. According to some embodiments, the hinge system also allows for pivoting about the main axis of pole 370 as shown by arrow 386 in FIG. 3A. According to some embodiments, the coiled spring unit 354 is not included and the angle of the hinge system 356 is controlled manually by other means. According to some embodiments, the hinge system 356 includes a motor for controlling the height of the housing 200.

According to some embodiments, base support 220 is configured for ease of secure attachment to the snow. In FIG. 3A, the base 220 includes a buried portion 372 of pole 370 beneath the snow surface (as shown by dashed lines in FIG. 3A). Base 220 also includes support legs 374, 376 and 378, that each also have some buried portions as shown by dashed lines in FIG. 3A. According to some embodiments. The portion 372 of pole 370 that is buried is approximately 2-3 feet, although other amounts are possible depending on the application. According to some embodiments, there are only 1 or 2 support legs, or no support legs depending on the application. According to some other embodiments, other type of anchoring systems can be used such as, snow and/or ice screws, that are screwed into snow surface 110 and/or the side of ramp 106. Many other anchoring systems could be used depending on the application.

According to some embodiments, an anemometer 390 can be provided as shown in FIG. 3B. An anemometer can be used to adjust the target approach speed ranges as wind speed and direction can affect the skier's trajectory and can have an effect on the condition of the snow. Examples of suitable anemometers include the Inspeed pole mount #PM25, although many other types of anemometers can be used depending on the application.

According to some embodiments, a separate jump-camera 366 is provided, for example on face 312 which is configured to record all users all day and store the data on local memory (not shown), which could be, for example, a flash drive. According to some embodiments, camera 366 can be a pi-type camera. Another example of a suitable camera is the BZB BG-Maestro digital out tracking camera. According to some embodiments, enhanced video and/or image capture could be recorded, saved and/or transmitted to users who have, for example, paid a subscription fee. According to some embodiments, the camera 366 is positioned within housing 200 such that it can “view” though window 322 the skiers flying or sailing through the air. According to some embodiments, the video captured by camera 366 is uplinked and/or transmitted to the skier's personal device, for example, according to a subscription paid by the skier. According to some embodiments, technology such as Bluetooth and/or RFID is used identify the skier such that the video is captured and/or delivered to each individual skier.

According to some embodiments, the system can be configured to identify a skier who is about to use or is using the terrain park feature the system is installed on. According to some embodiments, a wrist band can be worn by the skier that includes an RFID tag that is coded to be identifiable by a separate unit near the starting zone 104 or the system tower 100. Alternative technologies for identification include Bluetooth technology.

According to some embodiments, camera still images and/or video along with other time synchronized data such as determined speeds, conditions and record of what was being displayed on displays 320 and 330, can be stored locally or on network 160 (shown in FIG. 1). According to some embodiments, the data could be continuously logged, or it might be only recorded when a skier is using the terrain park feature. According to some embodiments, the time synchronized data, including associated metadata such as GPS information, is configured and securely stored so that it is tamper resistant and can be authenticated for possible subsequent use as digital evidence in a legal proceeding.

According to some embodiments a snow temperature sensor can be provided. In one example, a probe 396 is positioned in the snow surface as shown in FIG. 3A. According to another example, an inferred thermometer 398 is mounted, for example on one of the faces (310, 312, 316 or 318) of housing 200, shown in FIGS. 3A and 3B. According to some embodiments, either a probe type sensor or an inferred type sensor are used to make temperature measurements at one or more locations on or near the jump feature. For example, measurements can be made on the downward approach to the ramp, the ramp itself or the landing zone. According to some embodiments, readings can be made various snow surfaces that have characteristics that may affect the calculated target speed ranges. Such characteristics may include one or more of the following: slope aspect (e.g. north or south facing), slope angle, sun exposure, and wind exposure. Readings from one or both types of snow temperature sensors (probe and/or inferred), can be used by the computer system 334 so adjust the target speed ranges.

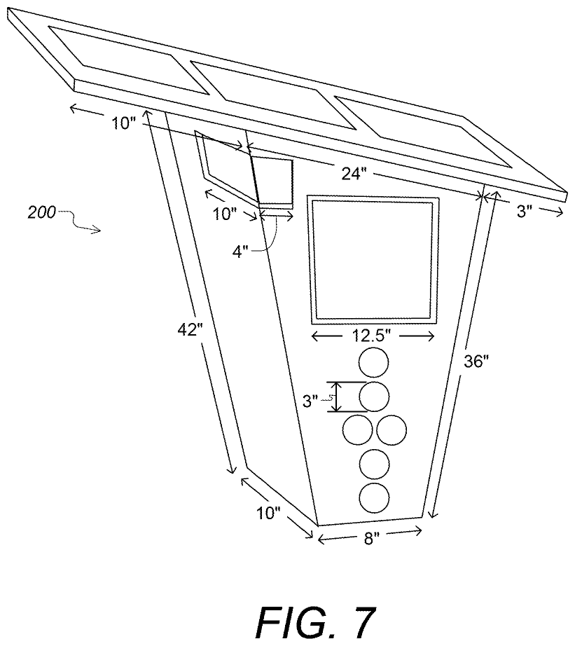

FIG. 3C shows a view of the downhill facing side 316 and away facing side 318, where, in this case, the arms 350 and 352 are attached to housing 200 on the upper end of downhill facing side 316 as shown. The dimensions are shown to be somewhat smaller than shown in FIG. 7.

FIG. 3D shows the system tower 100 mounted to the snow surface to the side of a terrain park jump feature 306, which is similar or identical to the jump feature shown in FIGS. 1 and 2. While the jump feature 306 still has an approach zone and landing zone, the jump feature 306 has a more rounded top and lacks a well-defined lip, table and knuckle portion. Mounting the system tower further from the feature may in some applications provide a better view and/or provide decreased risk of collision with the system tower. According to some embodiments, the system tower is located behind or near an existing structure.

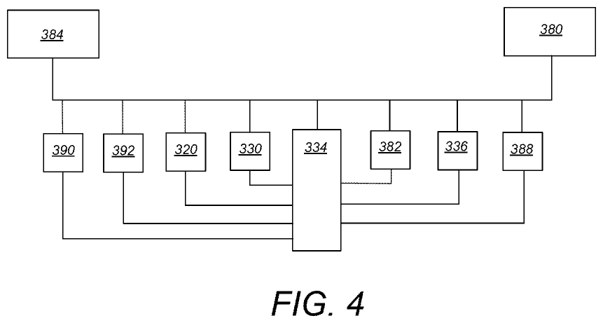

FIG. 4 is a schematic diagram illustrating further details of various components of a speed and landing zone management system and some interactions between such components, according to some embodiments. The electrical components including, LED display 320, light displays 330, computer system 334, camera 382 and lidar system 336, communications system 388 (which can include an LTE unit), anemometer 390, and heater 392 are supported either by battery 380 or wired power source via line 384. The computer system 334 integrates information from the camera 382 for video uplink and Lidar 336 to provide appropriate signals to skier via LED display 320 and/or light displays 330.

Lidar system 336 is positioned behind window 322 and for adequate viewing of both the approach and landing area. A camera 382 can be equipped to record video and/or still images to record the skier both jumping and landing. Communications between computer 334, skier 102 (and 102′) and/or network 160 shown in FIG. 1 is provided by communications system 388.

The method and arrangement of wiring or connecting the above electronic components and mounting them in the tower are well known to those with ordinary skill in application development and electric-mechanical integration.

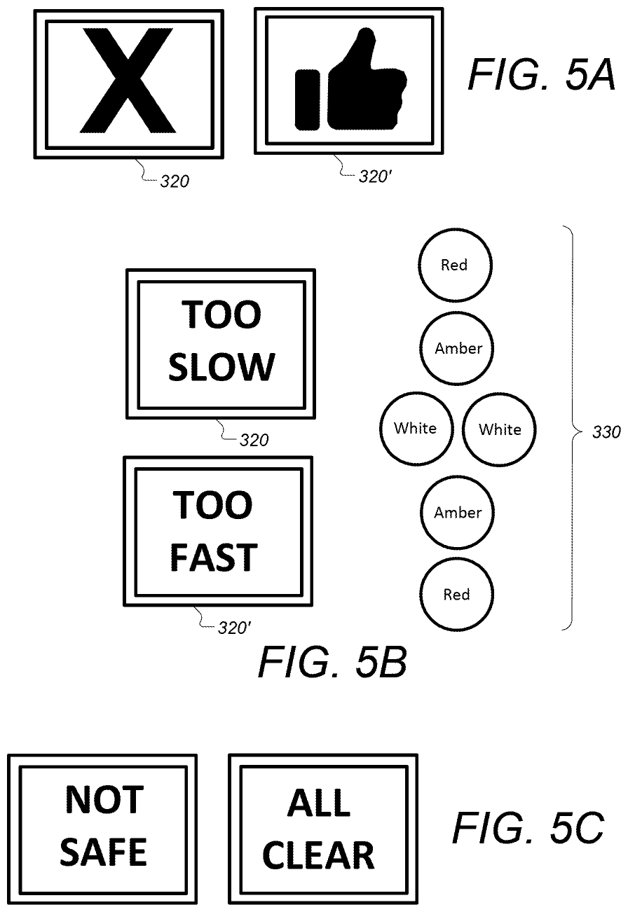

The computer system 334 interprets information from the lidar system 336 to determine the speed of skier 102 at various locations shown in FIG. 1. The computer determines whether the approach speed of skier 102 is within a target range, or whether it is too slow or too fast. In real time, the computer indicates to the skier via the lights 330 a warning when it detects that the skier is either going too slowly or too quickly. LED display 320 can also be used for the system making indications to the skier. According to some embodiments, LED display 320 is used to indicate to a skier in the take-off zone 104 (shown in FIG. 1) or otherwise approaching the ramp 106 that the landing zone is not clear and so take off from the ramp 106 and lip 114 (also shown in FIG. 1) is not advised. Further details of indications via lights 330 and LED display 320 are provided below in connection with FIGS. 5A-5C. According to some embodiments, a Lidar system is either not used, or is supplemented with one or more cameras run through the computer system. In some cases, using one or more cameras will provide sufficient monitoring of skier approach speed and/or landing zone clearance without the use of a lidar system. According to some embodiments, the camera and/or lidar system and computer system are configured to determine the skier's speed at more than one location as the skier approaches the jump. According to some embodiments, the camera and/or lidar system and computer system are configured to continuously monitor the skier's speed during some or all of the skier's approach to the jump, ramp and/or lip. Providing continuous monitoring can provide improved guidance to the skier in many applications.

According to some embodiments, the system uses the camera 382 to provide the skier with still image(s) and/or video images of the skier's jump and/or landing. Such images can increase the skier's enjoyment of the feature and/or correct issues found in the skier's form to improve the skier's skills and/or style for a more fulfilling and safer mountain experience.

The systems described in one or more embodiments, can allow participants to enjoy terrain parks while skiing alone, or with one or more additional people, by increasing safety and reducing risk. In addition, if with others, one skier does not need to bypass the feature to monitor the landing zone, but instead everyone can participate each time down the mountain. Therefore, the systems can increase daily value by increasing the number of runs per day as “participant” vs. as “safety spotter.”

FIGS. 5A-5C are diagrams illustrating further details of visual indicators to a user by a speed and landing zone management system, according to some embodiments. FIG. 5A shows an example of how LED display 320 can be used. the large “X” shown in 320 indicates that the landing zone is not clear, while the thumbs up symbol shown in 320′ indicates that that the objects are not detected in the landing zone. Various colors can be used to provide good visibility and communication. For example, the X could be red on a white background and the thumbs up can be amber on a white background.

FIG. 5B shows an example of using both LED display 320 and light display 330 to provide speed guidance to an approaching skier. If the speed is within the target range, then a pair of white lights in the middle of display 330 are lit. If the approaching skier is detected as too slow, the LED display 320 shows “TOO SLOW” while the amber and/or red lights below the white lights alert the user that they are moving too slow. If the approaching skier is detected as too fast, the LED display 320′ shows “TOO FAST” while the amber and/or red lights above the white lights alert the user that they are moving too fast. Other variations are possible. For example, if the approaching skier is slightly too slow then LED display can show “TOO SLOW” while the amber light is lit. If the approaching skier is going much to slow, the “TOO SLOW” can flash on and off and the red light can illuminate and/or also flash. Other verbal messages can be used such “ABORT” such as when the system detects that the speed is so far out of range that there is a even greater risk of injury, or for example when an object is detected in the landing zone (e.g. via lidar system 336 and/or camera 382) while a skier has already commenced an approach to the ramp at a speed that might cause a collision. Different gradations of warnings might be useful in some case since often an approaching skier can alter their speed, direction and amount of “pop” in response to the guidance. For example, in some cases 8 or more lights can be used to further fine-tune the skier's speed deviation from the target speed or target speed range and display different degrees of deviation from a selected speed range. According to some embodiments, one or more of the lights can also be either, off, flashing, or steady. According to some embodiments, the rate of flashing can change to make different indications. According to one example, as a skier accelerates towards the jump at a much higher than target speed, the upper red light flashes. As the skier checks, or “scrubs” some of their speed, the lights transition to amber flashing. As the skier further scrubs speed, the amber light becomes steady. When the skiers speed is in the target zone, the two white lights are steady. This methodology allows for the single amber light to represent 2 speed deviations.

According to another example embodiment, the LED display 320 displays a message in white “ALL CLEAR” which indicates no objects detected in the landing zone (e.g. via Lidar system 336 and/or camera 382). A message in red “NOT SAFE” provides an indication of objects detected and the feature should not be attempted.

According to some embodiments light colors can be used differently than described above. For example, the green lights might be used instead of white lights, or the display of no lights can be used to indicate that the user's speed is within a recommended range.

According to some embodiments, and LED system such as the 3×13″ LEDDIS LED outdoor module-RGB, WP008 could be used for the LED display 320 and 2-3″ 5-10 Watt LED-COB's could be used for lights display 330, from Luxx light technology, although many other light display systems can be used depending on the application.

Alternative ways in which the described systems can be utilized include other activities where correct approach speed is considered an important safety consideration and/or blind landing areas create risk. Examples of other embodiments include, but are not limited to, mountain bike jumping and motorcycle/motocross jumping.

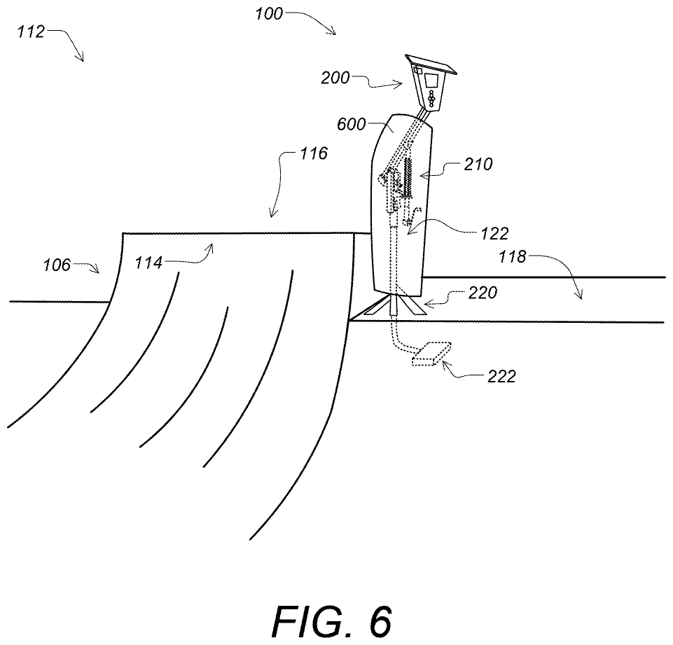

FIG. 6 is a diagram showing a speed and landing zone management system, according to some embodiments. In this case, padding 600 is used to reduce risk of injury if a skier were to accidently collide with any portion of the system tower 100. Padding 600 can be similar or identical to padding used to pad ski lift towers and/or snow making equipment. According to some embodiments, other types of protective apparatus can be used along or in combination with each other or with padding. Examples include protective netting, although many other types exist.

FIG. 7 is a diagram showing example dimensions for components of a speed and landing zone management system, according to some embodiments. Shown are various approximate sizes for a housing 200 such as shown in FIGS. 3A and 3B. According to some embodiments, the physical size of the various components of the system, including the housing, displays, poles, and bases could be modified to more appropriately fit smaller or larger features. According to some embodiments, the housing shape could be three sided, more rounded, or adjusted for desired applications like other displays and or banner marketing.

According to some embodiments, material used could be adjusted to better suit environmental and/or economical changes.

According to some embodiments, various combinations of lights and cameras can be custom suited to varying customer safety needs and/or preferences.

According to some embodiments, ski professionals such as those qualified to build the terrain park feature, can be utilized to test a feature to determine the most appropriate speed through numerous jumps and making accommodation for anticipated snow conditions. The ski professional's recommendations can be used to set computer parameters to reflect the appropriate speed for the feature. According to some embodiments, in the event of a system malfunction, a fail-safe integrated sensor will turn all light displays dark.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered as illustrative and not restrictive, and the body of work described herein is not to be limited to the details given herein, which may be modified within the scope and equivalents of the appended claims.

What it claimed is:

1. A system enhancing safety in a ski jump feature (112) that includes a run comprising, in a downstream sequence, a starting zone (104) for a skier (102) to start a run, a downwardly sloping zone (110) for the skier to build up speed, a ramp zone (106) from which the skier is to jump off, a flying zone over which the skier is to travel through the air, a landing zone (120) for the skier to land, and a zone (124) for the skier to end the run, and the run further comprises a side area (118) that is to a side of said flying zone, said system comprising;
a housing (200) mounted at said side area, spaced from said run, and supporting sensors (382, 336, 390) configured to monitor said run and further housing a computer 334 operatively coupled to the sensors;
wherein said sensors and computer are configured to:
individually detect the skier's speed in real time at each of multiple points in the run between the start zone and the end of the ramp zone;
track weather conditions at the run; and
detect the presence or absence of obstructions in said run;
plural displays (320, 330) positioned to be visible by the skier at least upstream of said flying zone and driven by said computer based on input from said sensors, to indicate to the skier:
the presence or absence of dangerous conditions at the run (FIG. 5A: 320, 320′);
in real time and at each of plural points in the run:
whether the skier's speed is within a selected range (330);
if the skier's speed is outside the selected range:
whether the speed is too fast or too slow relative to the selected range (FIG. 5B: 320, 320′); and
whether the departure of the skier's speed from the selected range exceeds a threshold (FIG. 5B: 330); and
a wireless communication facility (160, 164) configured to transmit, to a wireless personal device carried by the skier, at least some of the indications at said plural displays.

2. The system of claim 1, in which the sensors configured to track weather conditions at the run include an anemometer (390) measuring wind speed and direction at the run, and said computer responds to outputs from the anemometer to automatically adjust said selected speed range.

3. The system of claim 1, in which the sensors configured to individually detect the skier's speed at each of said multiple points comprise a camera system (382) viewing at least the ramp zone and supplying said computer with real time images, and said computer is configured to estimate the skier's speed at each of said multiple points based at least in part on said images.

4. The system of claim 1, in which the sensors configured to detect the presence or absence of obstructions in said run include a camera system (170) viewing the landing zone and the flat zone and supplying images thereof to said computer, and said computer is configured to process said images to detect the presence of absence of obstructions at the landing zone and the flat zone.

5. The system of claim 1, in which the sensors configured to detect the presence or absence of obstructions in said run include plural imaging devices (336, 366, 170) viewing the run from plural, spaced-apart viewing points.

6. The system of claim 1, in which said wireless facility configured to transmit to a wireless device carried by the skier is configured to cause the wireless device to issue audible and/or vibration indications conforming to at least some of the indications displayed at said plural displays.

7. The system of claim 1, in which said computer is further configured to receive empirical data regarding current run conditions derived by observations at the run at selected time intervals and to automatically adjust said selected speed range accordingly.

8. The system of claim 1, further including a fail-safe display (FIG. 5C) activated in case of a failure of displaying said indications to display a sign visible from the starting zone to the effect that the run is currently unsafe.

9. The system of claim 1, further including a facility (334, 388, 164) configured to store and selectively transmit to skiers and/or others still and/or video images taken with said sensors.

10. The system of claim 9, in which said still and/or video images are configured to enhance education and/or increase enjoyment of said ski jump feature.

11. The system of claim 1, in which the sensors configured to individually detect the skier's speed at each of multiple points comprise a Lidar (336), and said computer is configured to estimate the skier's speed at each of said multiple points based at least in part on input from said Lidar.

12. The system of claim 11, in which said sensors and computer are further configured to detect the skier's speed in real time continuously during at least part of the run between the start zone and the end of the ramp zone.

13. A speed and landing zone management system for a facility that includes a run comprising a ramp (106) over which a person (102) speeds and a terminal portion (114) that is at the end of the ramp and from which the person jumps toward a landing zone (120), the system comprising:
a supporting member (210) extending up from a base (220) supported at a site (118) that is spaced laterally from the terminal portion of the ramp to be outside the run, thereby reducing risks of the person colliding therewith;
a housing (200) supported by said supporting member;
sensors (382, 336, 170) at least some of which are at the housing and are configured to detect motion of the person on said ramp and selected parameters at said run;
a computer (334) operatively coupled with the sensors and configured to respond to inputs from the sensors to:
individually estimate, based on inputs from the sensors, the speed of the person on the ramp; and
determine the presence or absence of obstructions in the run;
at least one display operatively connected to the computer and configured to concurrently display to the person on the ramp each of:
real time indications, based on the estimates of the person's speed and whether the person's speed conforms to a selected speed range; and
real time indication of the presence or absence of obstructions in the run.

14. The system of claim 13, further including weather condition sensors (390, 396, 398) at said run, and wherein said computer is configured to respond to inputs from said weather condition sensors to automatically adjust said selected speed range for greater safety of persons using the run.

15. The system of claim 14, in which said weather condition sensors include a sensor of wind strength and direction at the run.

16. The system of claim 14, in which said weather condition sensors include sensors both for air and for snow temperatures at the run.

17. The system of claim 13, further including a wireless facility operatively coupled with said computer and configured to transmit to a wireless device carried by the person to cause the wireless device to issue an audible and/or vibration indication conforming to at least some of the indications displayed at said plural displays.

18. The system of claim 13, in which said sensors comprise a Lidar (336), and said computer is configured to estimate the person's speed at each of multiple points based at least in part on input from said Lidar.

19. The system of claim 13, in which said run is a ski jump run and said computer is further configured to detect, based on inputs from said sensors, the presence or absence of obstructions at said landing zone.

20. The system of claim 13, in which said run is a ski jump run and said computer is further configured to detect, based on inputs from said sensors, the presence or absence of dangerous conditions at a zone (124) downstream from said landing zone.

21. The system of claim 13 in which said sensors and computer are further configured to sense and detect the speed of the person at multiple locations approaching the terminal portion of the ramp.

22. The system of claim 13, in which said sensors and computer are further configured to detect the skier's speed in real time continuously during at least part of the run between the start zone and the end of the ramp zone.

23. A method of enhancing safety at a jump feature at which a person travels over a run that includes a ramp (106) and a landing zone (120), said method comprising:
individually estimating the person's real time speed at each of multiple points over the ramp by computer processing outputs of sensors that are mounted at a location (118) that is laterally offset from the run, extends higher than a lip (114) at the end of the ramp, and are supported at a base (116) that is vertically spaced from the lip;
monitoring the landing zone for obstructions in real time;
concurrently displaying, at one or more locations visible to a person traveling toward the lip:
indications of the presence of absence of obstructions in the landing zone based on said real time monitoring of the landing zone; and
indications whether the person's speed over the ramp conforms to a selected speed range based on said estimates of the person's real time speed at each of said multiple points over the ramp.

24. The method of claim 23, further comprising sensing selected weather conditions at the run and automatically adjusting said speed range with said computer based on the sensed weather conditions.

25. The method of claim 23, in which said concurrent displaying further includes displaying indications of a degree by which the person's speed is outside said selected speed range.
